(19) United States
(12) Patent Application Publication
(10) Pub. No.: US 2011/0057408 A1
(43) Pub. Date: Mar. 10, 2011

(54) AXLE ASSEMBLY

(75) Inventor: Hubert Koschinat, Deutschland (DE)

(73) Assignee: SAF-HOLLAND GMBH, Bessenbach (DE)

(21) Appl. No.: 12/375,850

(22) PCT Filed: Jun. 28, 2007
(86) PCT No.: PCT/EP07/05710

§ 371 Date: Aug. 6, 2009

(30) Foreign Application Priority Data
Aug. 9, 2006 (DE) 102006037356.1

(51) Int. Cl. B60B 35/04

(52) U.S. Cl. 280/124.11

(57) ABSTRACT

The invention concerns an axle assembly with a vehicle axle having a rigid axle body, e.g., one formed as an axle tube (8), with a radius arm (6, 7) on either side of the vehicle's longitudinal midplane, which can be linked at a first front end (9, 10) to a bearing point fixed to the chassis and is joined rigidly to the axle body (8) at a distance away from that point, and which forms the lower support of a spring element in the region of its rear end (17, 18), opposite the front end (9, 10), on top of which the vehicle chassis rests. The axle body (8) and the two radius arms (6, 7) are formed jointly from two shaped part halves (2, 3) which are essentially single-piece and joined together, particularly by welding, along a joint (4) running in the essentially horizontal plane, for example, so that the axle body (8) rigidly joins together the two radius arms (6, 7). The axle body (8) is stiffened by at least one extra stiffening element (15, 16; 17; 18; 19, 20) at least in the junction regions of the axle body (8) with the two radius arms (6, 7).

The invention concerns an axle assembly with a vehicle axle having a rigid axle body, e.g., one formed as an axle tube, with a radius arm on either side of the vehicle's longitudinal midplane, which can be linked at a first front end to a bearing point fixed to the chassis and is joined rigidly to the axle body at a distance away from that point, and which forms the lower support of a spring element in the region of its rear end, opposite the front end, on top of which the vehicle chassis rests, while the axle body and the two radius arms are formed jointly from two shaped part halves which are essentially single-piece and joined together, particularly by welding, along a joint running in the essentially horizontal plane, for example, so that the axle body rigidly joins together the two radius arms.

Such an axle assembly is known, e.g., from DE 101 18 523 A1 or from DE 100 53 411 A1. Such axle assemblies made from two shell-type shaped part halves have the advantage that the manufacturing and assembly cost as well as the weight can be reduced with low fabrication costs. However, it has been found in certain application cases that very large material stresses occur under high loading of the axle assembly during operation, especially in the junction region between the axle tube and the radius arms.

Therefore, one problem of the present invention is to modify an axle assembly of the above mentioned kind so that the reliability and stability of the axle assembly is further improved, without significantly increasing the production and assembly expense. According to the invention, this problem is solved in an axle assembly of the above mentioned kind in that the axle body is stiffened by at least one extra stiffening element at least in the junction regions of the axle body with the two radius arms. This configuration of the axle assembly from relatively thin shaped part halves and a definite additional stiffening in the most highly stressed regions makes it possible to provide an especially reliable axle assembly with minimized weight.

According to a first embodiment of the invention, the at least one stiffening element is formed by a tube, which is inserted into a cavity formed by the two shaped part halves. When the axle assembly is configured with, e.g., an inner cylindrical axle tube, it makes sense to introduce an outer cylindrical tube into this for stiffening. However, it is also possible for the stiffening element to have a noncircular cross section, in particular, a cross section optimized in regard to the stresses which occur.

The region of the axle tube between the two radius arms is subjected to a high bending stress during operation, among other things. Therefore, in certain applications, it is preferable for this middle region of the axle tube to have a larger cross section than the outer side ends of the axle tube, at which the stub axles can be provided. In such a configuration of the axle tube, the tube serving as the stiffening element is preferably configured as a tube which is at least partly conical from the outside of the axle tube in the direction of the middle of the axle tube.

According to another embodiment of the invention, the at least one stiffening element is formed by a tubular elongation of the stub axles. Thus, after the two shaped part halves are joined together to form the axle assembly, only the elongated stub axles need to be inserted, without requiring additional costly stiffening procedures.

In a further modification of the invention, it is provided that the at least one stiffening element lies at least partly in sheetlike manner against the inner wall of the two shaped part halves. Thus, the stiffening element can be clamped or braced against the axle assembly formed by the two shaped part halves. Alternatively or additionally to this, it is also possible to weld the at least one stiffening element at least partly to the two shaped part halves. The stiffening element can either be configured as a continuous stiffening element that is shoved into the axle tube, or one can provide stiffening elements separated from each other, especially in the junction region between the radius arms and the axle tube.

According to another embodiment of the invention, the at least one stiffening element is braced on the inside in the axle assembly formed by the two shaped part halves. For this, it is provided that the lateral end segment of the axle tube is configured to be cylindrical on the inside, the stiffening element configured in particular as a stub axle is fitted by a corresponding outwardly cylindrical connection segment into the end segment of the axle tube, and the end segment of the axle tube can be radially braced against the connection segment of the stiffening element by means of at least one clamping piece, which can be adjusted by means of a threaded bolt in the axial direction toward the end of the axle tube.

As an alternative to this, it is also possible to provide an outside bracing between the axle assembly and the at least one stiffening element. In this case, the lateral end segment of the axle tube is configured cylindrical on the inside and with at least one longitudinal slit, while the stiffening element configured in particular as a stub axle is fitted by a corresponding outwardly cylindrical connection segment into the end segment of the axle tube and the end segment of the axle tube is radially braced against the connection segment of the stiffening element by means of at least one clamping ring seated on the end segment of the axle tube and slit continuously in the lengthwise direction.

According to another preferred embodiment of the invention, the at least one stiffening element is formed by a rib, which is arranged in a cavity formed by the two shaped part halves and welded in particular to the shaped part halves. Thanks to the configuring of riblike stiffening elements, a further weight savings can be achieved if the ribs are designed and arranged in the axle assembly in accordance with the stresses which occur.

In a further modification of this notion of the invention, it is preferred to provide at least two stiffening elements, each of them formed by at least two ribs running at least approximately perpendicular to each other. One of the ribs can lie at least approximately in a plane with the longitudinal axis of a radius arm and another rib can lie at least approximately in a plane with the axis of the axle tube. Thus, the stiffening elements are to be provided in the region of the connection between the radius arms and the axle tube, which is the most heavily stressed during operation.

In some applications, it is preferable to provide through openings in the axle assembly, e.g., to receive functional elements of a brake system. These through openings allow the accommodation of functional elements, without needlessly increasing the construction space in the region of the wheel suspension. The stability of the axle assembly can be enhanced by installing an annular wall in the through opening and welding it to the shaped part halves.

The shell-type shaped part halves can be made cheaply from sheet metal in large lot numbers with little expense, by using suitable pressing or forging tools. A clamping or welding of separate radius arms, e.g., to the axle body, and also the labor-intensive assembly of the radius arms from several wall elements, can be dispensed with. A welding may be needed to attach the reinforcement elements and also only to join the two shaped part halves in the region of the essentially horizontally running joints, for example, where the loads are not as large. Furthermore, the shape pressing of the shaped part halves enables a weight and load optimized distribution of wall thicknesses in the axle assembly. Thus, for example, it is possible to increase the material thickness in the highly loaded region of the connection of the radius arms to the axle body and decrease it accordingly in less heavily loaded regions. The axle assembly of the invention in this way achieves high rigidity with low weight at the same time.

The rigidity of the axle assembly with low weight is further enhanced when the two shaped part halves are joined together to form a cavity between them. Bending moments and torques acting on the axle assembly can be especially well absorbed in this box type construction.

If a bearing sleeve is configured or placed at the front ends of the radius arms for joining the radius arm to the vehicle chassis, it is possible to employ bearing sleeves individually matched to the vehicle chassis while leaving the geometry of the axle assembly unchanged. Furthermore, different materials can be used in this way for the bearing sleeves and the shaped part halves, for example, bearing sleeves made of copper alloys. The bearing sleeves can be secured especially easily and permanently to the radius arms, so that the stability of the axle assembly is further increased at the same time.

The axle assembly of the invention can be used with various vehicle chassis types, if several through boreholes running essentially perpendicular to the plane of the joint are provided at the rear ends of the radius arms, in order to attach spring elements to the radius arms. Depending on the size of the spring elements, which are preferably each formed by pneumatic spring bellows, and the geometry of the vehicle chassis, the spring elements will be secured in different through holes, for example, by means of threaded stems. Thanks to the broad applicability of the axle assembly with different vehicle chassis types, the fabrication costs and especially the costs for the tools and dies of the shaped part halves can be kept low. The shock absorber can be attached in familiar fashion.

For the attachment of wheels to the axle assembly, an axle journal is rigidly fastened preferably in both side openings of the axle body. This axle journal can be pressed, for example, into the axle body, fashioned as an axle tube, and be welded to it or otherwise joined to the axle assembly. In this way, it is possible to employ axle journals of different dimensions for the same geometry of the axle assembly.

According to another embodiment of the invention, roller bearings are provided in both side openings of the axle body. In this embodiment, the wheels can be in the bearing unit in the axle body via an extension of the wheel hub. Also in this embodiment of the axle, the configuration of the wheels or the brakes is largely independent of the geometry of the axle assembly, so that it can be used variably for different vehicle types.

In the following, a sample embodiment of the invention shall be explained more closely, making reference to the drawing.

This shows:

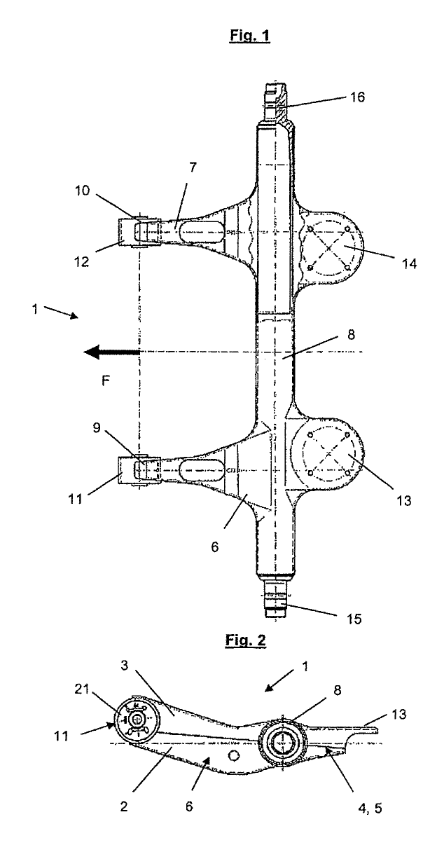

FIG. 1, in partly sectional top view, an axle assembly according to a first embodiment of the invention,

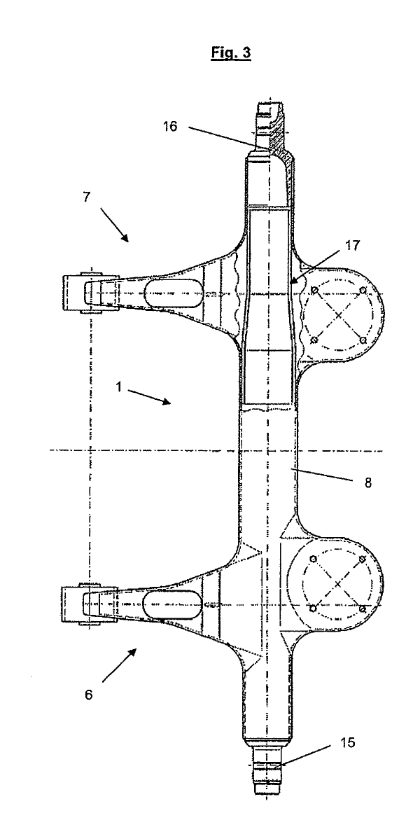

FIG. 2, the axle assembly of FIG. 1 in side view,

FIG. 3, in partly sectional top view, an axle assembly according to a second embodiment of the invention,

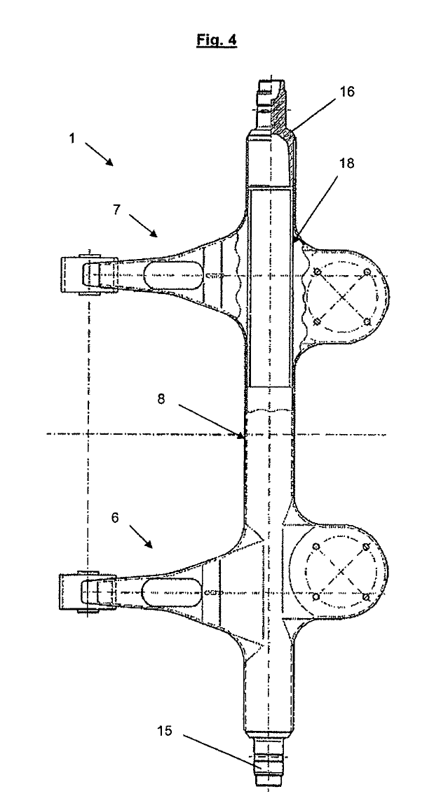

FIG. 4, in partly sectional top view, an axle assembly according to a third embodiment of the invention,

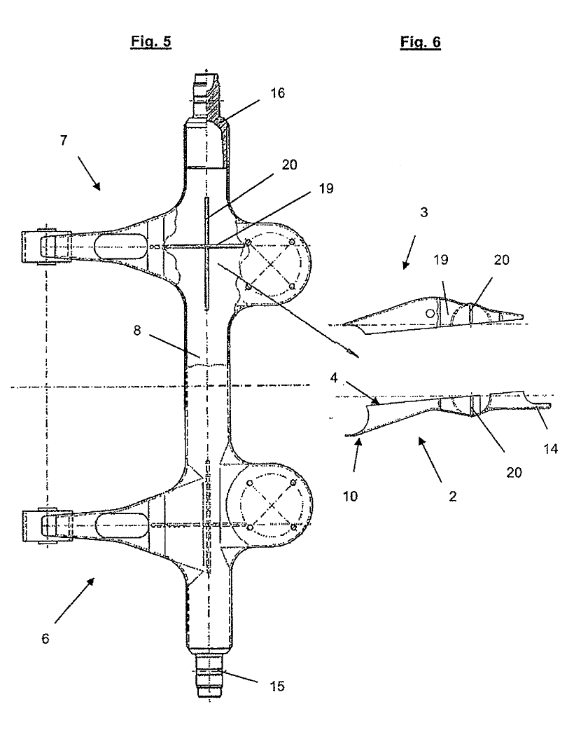

FIG. 5, in partly sectional top view, an axle assembly according to a fourth embodiment of the invention, and

FIG. 6, a section through the shaped part halves of the axle assembly of FIG. 5.

The embodiments depicted in FIGS. 1, 3, 4, and 5 are basically identical in terms of the fundamental layout of the axle assembly 1. The axle assembly 1 here is assembled from a lower shaped part half 2 and an upper shaped part half 3. The two shaped part halves 2 and 3 are connected to each other along a joint 4 running essentially horizontally by a weld 5 and define a cavity between themselves. The two shaped part halves 2 and 3 are each profiles pressed or forged from sheet metal, which can have a wall thickness of several centimeters, for example, around 5 mm.

Each of the shaped part halves 2 and 3 is configured in the shape of an H, with two radius arm halves essentially parallel to each other. The radius arm halves are joined together in a single piece via axle body halves so that the axle body halves run approximately perpendicular to the radius arm halves. The radius arm halves when assembled form radius arms 6 and 7, in whose middle region the axle body 8 assembled from the axle body halves branches off in the form of an axle tube. In the embodiment depicted, the axle tube 8 has a diameter of around 200 mm.

The front end 9 and 10 of the radius arms 6 and 7, in terms of the direction of travel as indicated by the arrow F, can be linked to a bearing point on the vehicle chassis (not shown in the figure). For this, a bearing sleeve 11 and 12 is configured or arranged in the front ends 9, 10 of the radius arms 6, 7. In the embodiment shown in the figure, the front end 9 and 10 of the radius arms 6 and 7 has a semi-cylindrical recess for this purpose, in which the annular bearing sleeve 11 and 12 is welded all around. On the inside of the bearing sleeves 11 and 12, elastic bearing elements 21 can be press-fitted, such as a rubber-metal composite, which divert all forces occurring there across support lugs to the vehicle chassis and ensure the desired rolling stability of the vehicle.

Through boreholes are provided in the rear flattened ends 13, 14 of the radius arms 6, 7 in terms of the direction of travel F. By means of threaded stems, spring elements (not shown) can be attached to the radius arms 6 and 7 in one or more of the through holes, so that the rear ends 13, 14 of the radius arms 6, 7 form abutments for these spring elements, such as a pneumatic spring bellows, on the top side of which the vehicle chassis is supported.

In the embodiment depicted in FIG. 1, stub axles 15 and 16 are received in the opposite side openings of the axle body 8 and they are press-fitted and/or welded in the axle tube opening. One or more wheels (not shown) can be accommodated on the stub axles 15, 16 in familiar fashion. For this, the stub axles 15, 16 have threaded segments on their outwardly facing ends. In this embodiment, the stub axles 15, 16 have a longer length in the axial direction of the axle tube as compared to traditional stub axles, so that the tubular stub axles 15, 16 extend beyond the region of connection of the radius arms 6, 7 to the axle tube 8. The lengthened stub axles 15, 16 thus serve as a stiffening element, which lies in sheetlike manner against the inner wall of the axle assembly formed by the two shaped part halves 2, 3 and strengthens the region where the radius arms 6, 7 emerge into the axle tube 8, which is under especially high stress in operation.

FIG. 3 shows a second embodiment of the invention, which basically corresponds to the embodiment per FIGS. 1 and 2. In this embodiment, however, the stub axles 15, 16 inserted into the axle tube 8 at the side are not lengthened, but rather formed with traditional length and welded and/or clamped in the axle tube 8. To stiffen the region of connection between the radius arms 6, 7 and the axle tube 8, a partly conical tube 17 is provided as a stiffening element in the axle tube 8.

The partly conical tube 17 extends from a lateral outside region of smaller diameter, bordering on the region of fastening of the stub axles 15, 16, to a central region of the axle tube 8 with a diameter enlarged for stability reasons, situated between the two radius arms 6, 7. The high-stressed zone during operation, where the two radius arms 6, 7 emerge into the axle tube 8, is further strengthened by the stiffening element 17. The other regions of the axle assembly formed from the two shaped part halves 2, 3, on the other hand, can be formed from a relatively thin sheet metal, so that the axle assembly 1 has an especially low weight with high rigidity.

The embodiment of an axle assembly 1 shown in FIG. 4 basically corresponds to the embodiment of FIG. 3, while the central region of the axle tube 8 situated between the two radius arms 6, 7 does not have a diameter enlarged with respect to the region situated at the sides outside from the two radius arms 6, 7. The tube 18 received in the axle tube 8 as a stiffening element 18 can therefore be of cylindrical configuration, for example. The cylindrical tube 18, in turn, extends between a region bordering the stub axles 15 and 16, across the region of connection of the axle tube 8 to the two radius arms 6, 7, into a central region of the axle body 8. The cylindrical tube 18 can be clamped, welded, or otherwise secured in the axle tube 8, like the conical tube 17 shown in FIG. 3.

In the embodiment depicted in FIGS. 5 and 6, ribs 19, 20 are provided as stiffening elements, extending in the interior of the cavity formed by the two shaped part halves 2, 3. One rib 19 is arranged so that it extends at least approximately in a plane with the longitudinal axis of the front end 9 and 10 of the respective radius arm 6, 7. A second rib 20 extends essentially perpendicular to this in a plane of the axis of the axle tube 8. The length of the ribs 19, 20 is dimensioned so that they extend basically in the connection region between the two radius arms 6, 7 and the axle tube 8.

The two ribs 19, 20 are provided in the two shaped part halves 2, 3 in such a way that they emerge from the shaped part halves 2, 3 and end essentially in the plane of the joint 4. In this way, it is possible to join together the ribs of the respective shaped part halves when the two shaped part halves are joined together. Alternatively, however, it is also possible to weld the ribs together in advance or afterwards, or to provide continuous ribs which start from one shaped part half and extend into the other shaped part half.

The size and arrangement of the ribs 19, 20 is not limited to the embodiment shown in FIGS. 5 and 6. Rather, it is also possible, for example, to provide a larger number of ribs in the region of connection between the radius arms 6, 7 and the axle tube 8.

### LIST OF REFERENCE NUMBERS

1 axle assembly
2 lower shaped part half
3 upper shaped part half
4 joint
5 weld
6 radius arm
7 radius arm
8 axle body (axle tube)
9 front end of the radius arm 6
10 front end of the radius arm 7
11 bearing sleeve
12 bearing sleeve
13 rear end of the radius arm 6
14 rear end of the radius arm 7
15 stub axle
16 stub axle
17 conical tube
18 cylindrical tube
19 rib
20 rib
21 bearing element
F direction of travel

1. Axle assembly with a vehicle axle having a rigid axle body, e.g., one formed as an axle tube (8), with a radius arm (6, 7) on either side of the vehicle's longitudinal midplane, which can be linked at a first front end (9, 10) to a bearing point fixed to the chassis and is joined rigidly to the axle body (8) at a distance away from that point, and which forms the lower support of a spring element in the region of its rear end (17, 18), opposite the front end (9, 10), on top of which the vehicle chassis rests, while the axle body (8) and the two radius arms (6, 7) are formed jointly from two shaped part halves (2, 3) which are essentially single-piece and joined together, particularly by welding, along a joint (4) running in the essentially horizontal plane, for example, so that the axle body (8) rigidly joins together the two radius arms (6, 7), characterized in that the axle body (8) is stiffened by at least one extra stiffening element (15, 16; 17; 18; 19, 20) at least in the junction regions of the axle body (8) with the two radius arms (6, 7).

2. Axle assembly per claim 1, characterized in that the at least one stiffening element is formed by a tube (15, 16; 17; 18), which is inserted into a cavity formed by the two shaped part halves (2, 3).

3. Axle assembly per claim 2, characterized in that the tube (15, 16; 18) is a cylindrical tube.

4. Axle assembly per claim 2, characterized in that the tube (17) is a tube which widens conically at least partly from the outside of the axle tube (8) in the direction of the middle of the axle tube (8).

5. Axle assembly per one of claims 1 to 4, characterized in that the at least one stiffening element (15, 16) is formed by a tubular elongation of the stub axles (15, 16).

6. Axle assembly per one of claims 1 to 5, characterized in that the at least one stiffening element (15, 16; 17; 18; 19, 20) lies at least partly in sheetlike manner against the inner wall of the two shaped part halves (2, 3).

7. Axle assembly per one of claims 1 to 6, characterized in that the at least one stiffening element (15, 16; 17; 18; 19, 20) is at least partly welded to the two shaped part halves (2, 3).

8. Axle assembly per one of claims 1 to 6, characterized in that the lateral end segment of the axle tube (8) is configured to be cylindrical on the inside, the stiffening element configured in particular as a stub axle (15, 16) is fitted by a corresponding outwardly cylindrical connection segment into the end segment of the axle tube (8), and the end segment of the axle tube (8) can be radially braced against the connection segment of the stiffening element by means of at least one clamping piece, which can be adjusted by means of a threaded bolt in the axial direction toward the end of the axle tube (8).

9. Axle assembly per one of claims 1 to 6, characterized in that the lateral end segment of the axle tube (8) is configured cylindrical on the inside and with at least one longitudinal slit, while the stiffening element configured in particular as a stub axle (15, 16) is fitted by a corresponding outwardly cylindrical connection segment into the end segment of the axle tube (8) and the end segment of the axle tube (8) is radially braced against the connection segment of the stiffening element by means of at least one clamping ring seated on the end segment of the axle tube (8) and slit continuously in the lengthwise direction.

10. Axle assembly per claim 1, characterized in that the at least one stiffening element is formed by a rib (19, 20), which is arranged in a cavity formed by the two shaped part halves (2, 3) and welded in particular to the shaped part halves (2, 3).

11. Axle assembly per claim 10, characterized in that at least two stiffening elements (19, 20) are provided, each of them formed by at least two ribs (19, 20) running at least approximately perpendicular to each other.

12. Axle assembly per claim 10 or 11, characterized in that one of the ribs (19) lies at least approximately in a plane with the longitudinal axis of a radius arm (6, 7) and another rib (20) lies at least approximately in a plane with the axis of the axle tube.
